(19) United States
(12) Patent Application Publication
(10) Pub. No.: US 2026/0302600 A1
(43) Pub. Date: Oct. 1, 2026

(54) NEAR-FIELD COMMUNICATION RING

(71) Applicant: Infineon Technologies AG, Neubiberg (DE)

(72) Inventors: Walther Pachler, Graz (AT); Christoph Hermann, Graz (AT); Josef Gruber, Sankt Ruprecht An Der Raab (AT); Jürgen Hölz, Graz (DE)

(21) Appl. No.: 19/340,500

(22) Filed: Sep. 25, 2025

(30) Foreign Application Priority Data
Sep. 26, 2024 (DE) 102024209349.1

(51) Int. Cl. H01Q 1/27; H01Q 7/00

(52) U.S. Cl. CPC H01Q 1/273; H01Q 7/00

(57) ABSTRACT

A near-field communication ring designed to be worn by a user, wherein the near-field communication ring includes at least one storage device, a chip, a first antenna, at least one winding of which runs around at least 90% of the inner circumference of the near-field communication ring, and a second antenna with at least one winding that runs around no more than 20% of the inner circumference of the near-field communication ring. The chip is designed to provide a near-field data exchange with an external device using the first antenna and to charge the energy storage device with the aid of the second antenna.

### TECHNICAL FIELD

Various aspects generally relate to a near-field communication ring.

### BACKGROUND

Recently, performing payments, authentication, and other functions with the aid of body-wearable devices has become increasingly attractive. Rings are an innovative option for paying contactlessly. These small, ring-shaped devices are worn on the finger and allow payments to be made with just one hand movement. Through the integration of near-field communication (NFC) technology, the rings can communicate with payment terminals and authorize payments. The latest generation of NFC rings goes another step further. These rings are equipped with a battery and thus extend the usage possibilities with a variety of functions, such as fitness tracking for example. A plurality of near-field communication ring products (NFC ring products) are currently available. However, they may not be optimized with regard to design and performance. Multiple improvements may be possible.

As illustrated in FIG. 1, which shows a standard antenna design with a rectangular flexprint which is accommodated on a ring structure, an NFC ring according to the prior art can contain a standard flexprint PCB, which can realize a coil antenna. Flexprint technology may offer several advantages. It can for example be used as an NFC chip carrier, wherein a chip which is attached to a flexprint using standard bonding, flip chip or the like makes it possible to realize very precise antenna parameters, may provide a technically robust technology, may be inexpensive to mass produce and may make the use of a non-conductive carrier, e.g. a plastic carrier, possible.

According to DE 10 2017 104 0 46A1, an antenna runs in a metal ring. The metal ring itself is interrupted by at least one insulating break to avoid shielding by the ring.

WO 2023/094865 A1 discloses a near-field communication ring in which a protective device underneath protects the antenna and microchip.

However, it has been established that although transmission powers using the rings from the prior art may be sufficient, they may be limiting.

### SUMMARY

A near-field communication ring is provided, which is designed to be worn by a user, wherein the near-field communication ring comprises at least one energy storage device, a chip and a first antenna, the at least one winding of which runs around at least 90% of the inner circumference of the ring. A second antenna with at least one winding runs around no more than 20% of the inner circumference of the ring. The chip is designed in such a way that it provides a near-field data exchange with an external device using the first antenna and can charge the energy storage device with the aid of the second antenna.

A person skilled in the art will discern further features and advantages of the aspects of the disclosure upon reading the following detailed description and examining the attached drawings.

### BRIEF DESCRIPTION OF THE DRAWINGS

The present disclosure is shown in an exemplary and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows a near-field communication ring from the prior art.

FIG. 2 shows a circuit for a section of a circuit which is realized with the aid of the ring.

FIG. 3 shows further details of the circuit from FIG. 2.

FIG. 4 discloses a view of a ring for near-field communication.

FIG. 5 illustrates a pick-up device for a ring together with a ring.

### DETAILED DESCRIPTION

It should be pointed out that the description and the drawings only illustrate the principles of the proposed methods and devices. A person skilled in the art will be capable of implementing different arrangements which, although they are not expressly described or shown here, embody the principles of the disclosure and are contained within the scope thereof. In addition, all examples and aspects outlined in the present document are intended fundamentally and expressly for explanatory purposes only, in order to help the reader understand the principles of the proposed methods and devices. In addition, all statements in this document that describe principles, aspects of the disclosure and specific examples thereof are also intended to encompass their equivalents.

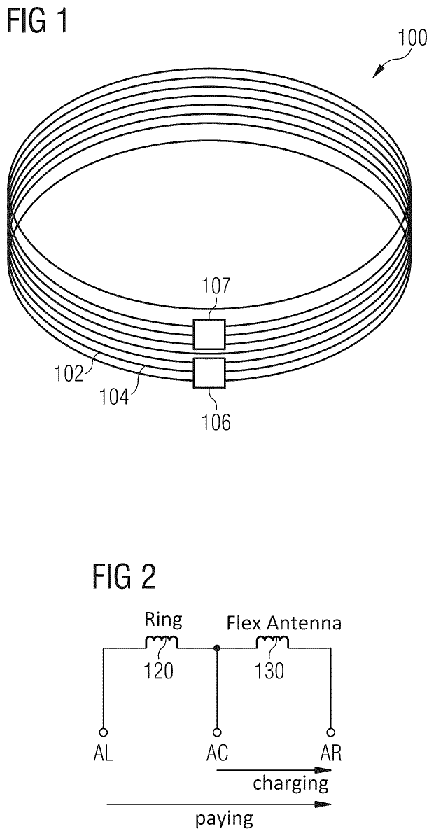

FIG. 1 shows a schematic perspective view of a conventional NFC ring 100. The

NFC ring 100 can have an antenna 102 which is arranged on a carrier 104. The NFC ring 100 further has a chip 106, e.g. a semiconductor chip 106, and an adjustment circuit 107 which may allow a simpler adaptation of antenna parameters to a desired impedance of the one antenna 102. Some NFC rings 100 may further have an encapsulation, e.g. a plastic and/or ceramic encapsulation (not shown here), which encapsulates the chip 106 and the antenna 102, e.g. for mechanical stabilization, for protection from environmental influences, e.g. moisture, dust, grease, etc., and possibly also for aesthetic reasons.

FIG. 2 discloses a portion of the circuit which should be realized with the aid of a near-field communication ring 100. A first antenna 120 is realized with the aid of the ring. The two ends of this first antenna 120 are connected to the nodes AL and AC. The ends of a second antenna 130, the so-called flex antenna, are connected to the nodes AC and AR respectively. AC is therefore the connection node or central node. The first antenna 120 for example has an inductance of 50 nF to 200 nF, the second antenna 130 has an inductance of 100 nF to 1 μF.

If an energy storage device 150 of the ring 100, for example a battery, should be charged, a coupling between an antenna of a contactless charger is achieved by an at least partially overlapping second antenna 130. By means of the second antenna 130, which is large relative to the first antenna 120, a coupling with a high coupling factor (for example k=0.1) to a contactless charger is possible. In addition, the ring-shaped large structure of the second antenna 130 improves the positioning tolerances in relation to a contactless charger.

A series connection of both antennas 120 and 130 is used for paying with the aid of the near-field communication ring 100.

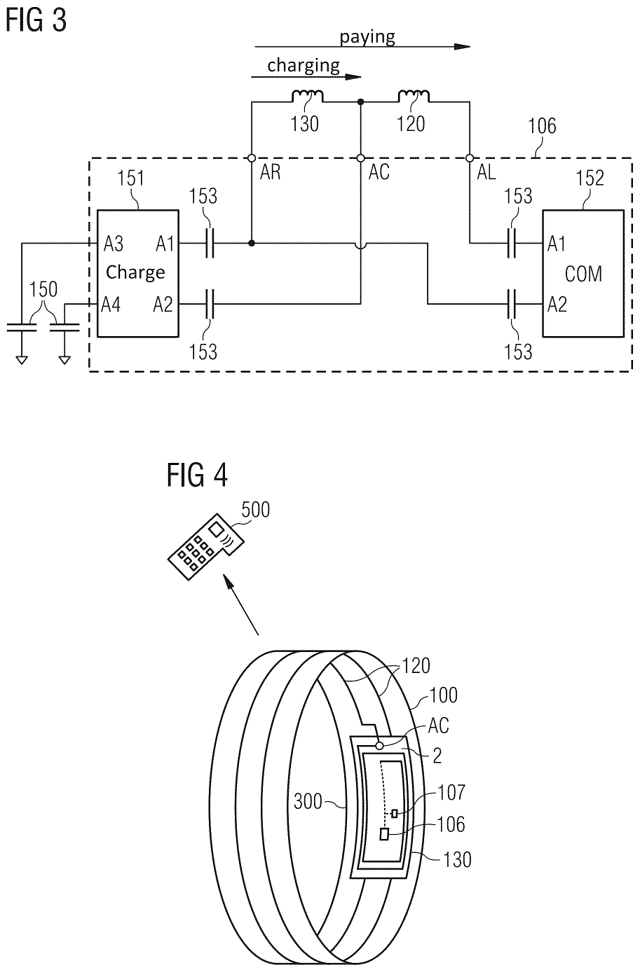

FIG. 3 shows further elements of the circuit, which is partially shown in FIG. 2. The circuit has an energy storage device 150, for example a battery, a charging circuit 151, a communication circuit 152 and coupling capacitors 153, wherein the coupling capacitors 153 can have different capacitances. In this design, the charging circuit 151, the communication circuit 152 and the coupling capacitors 153 are part of the chip 106.

The charging circuit 151 is an AC/DC converter which is connected using two of its connectors to the nodes AR and AC via coupling capacitors 153. More precisely, a connector A1 of the charging circuit 151 is connected to a connector of a first coupling capacitor 153, the second connector of which is connected to the node AR. In contrast, a second connector A2 of the charging circuit 151 is connected to a first connector of a capacitor 153, the second connector of which is connected to the node AC. First connectors of the energy storage device 150 are connected to the connectors A3 and A4 of the charging circuit 151, the second connectors of which are each connected to ground.

When the second antenna 130 is excited by a field, voltages and currents at or through the nodes AC and AR change. The corresponding energy is supplied to the charging circuit 151, which converts it as a voltage converter which charges the energy storage device 150 with the aid of the received energy.

A communication circuit 152 is connected using its connector A1 to the node AL via a capacitor 153 and using the connector A2 to the connector AR via a capacitor 153. When communication takes place by means of the communication circuit 152, the communication circuit 152 excites the series circuit of the first antennas 120 and the second antenna 130 and thus causes the antennas to transmit an electromagnetic signal. This signal can be received by a reader, with the aid of which, a cashless payment for example or an authentication of the wearer of the near-field communication ring 100 is carried out.

In the opposite direction, the first antenna 120 and the second antenna 130 receive an electromagnetic signal, which is forwarded via the coupling capacitors 153 to the communication circuit 152. The communication circuit 152 processes the signal and decodes it. The communication circuit 152 makes it possible to use the ring to make payment or makes it possible for the user to authenticate themselves.

A mode in which communication takes place is referred to as the first mode. A further mode, in which charging essentially takes place, is referred to as the second mode.

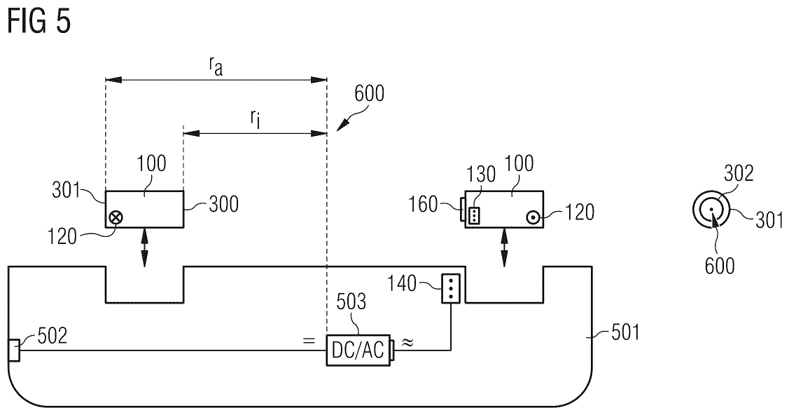

FIG. 4 shows a perspective view of a near-field communication ring 100 using which payment can be made. There are different designs for the shape of the near-field communication ring 100. The near-field communication ring 100 can have the shape of a hollow cylinder, the shape of a torus or the shape of a wedding ring, which differs from the torus in that the inside is straight, or all points on the inside have a substantially equal distance from the central axis of the near-field communication ring 100.

The near-field communication ring 100 has a first antenna 120 which runs at least around the inner circumference 300 of the near-field communication ring 100. In many exemplary aspects, it is preferred that the near-field communication ring 100 runs along the outer circumference. The first antenna 120 is possibly separated at the outer side from the outside world only by an insulating, water-repellent or dirt-repellent protective layer. In this case, the protective layer forms the part of the near-field communication ring 100 furthest from the central axis of the near-field communication ring 100.

The first antenna 120 can be produced for example by the near-field communication ring 100 having a recess which runs concentrically around the central axis of the near-field communication ring 100. A wire is placed into this recess, which thus takes the shape of one winding or the shape of two windings.

In addition, a carrier plate 2 is provided, which is realized as a printed circuit board (PCB) and carries the second antenna 130. The carrier plate 2 additionally carries a chip 106 and an adjustment circuit 107. The charging circuit 151 and the communication circuit 152 from FIG. 3 and further components are accommodated in the chip 106. The capacitors 153 from FIG. 3 can be part of the chip 106 or part of the adjustment circuit 107. In a further exemplary aspect, the circuit from FIG. 3 can also be formed using discrete components. The carrier plate 2 is bent so that it follows the shape of the ring 100. However, the carrier plate 2 does not run around the whole of the inner circumference, but only in a region that covers less than 20% of the inner circumference. Accordingly, the second antenna 130 likewise extends only along less than 20% of the inner circumference. In the present design, the second antenna 130 has two windings.

The second antenna 130 is primarily used for communication with external devices when the wearer wears the near-field communication ring 100 on the finger. The wearer brings the outside of the near-field communication ring 100 closer to an external device 500 to start the communication. It has been established that a good transmission is possible if the sizes and shapes of the antennas in the external device 500, here a payment terminal, and near-field communication ring are as close as possible to each other. A near-field communication ring 100 of this type does not need to be guided to the reader completely or does not also have to almost touch it, but in designs, communication between near-field communication ring 100 and external device 500 can take place at a distance of a few centimetres, e.g. 3 cm or 4 cm, already.

It may even be sufficient if the first antenna 120 only has one winding which does not run around the central axis completely, but almost completely, and the radius of the winding corresponds approximately to the radius of the outside of the near-field communication ring 100. Even with such an easy-to-manufacture design, good transmission powers are achieved, that is even at distances of a few centimeters, the two subscribers, near-field communication ring 100 and external device 500, can pick up the signal sent by the respective other subscriber in such a way that they can decode the signals. Accordingly, the second antenna 130 is limited to less than 5 windings, so that it can be implemented more easily on the carrier 104.

In a further exemplary aspect, the first antenna 120 can be formed directly from the metallic carrier of the near-field communication ring 100, wherein the connector AR and the connector AC here are galvanically connected to the metallic carrier of the near-field communication ring 100.

The first antenna 120 has an essential function in charging the energy storage device 150 of the near-field communication ring 100. Although it is possible also to charge at the same time as when receiving signals from the external device 500, more energy can be transmitted in particular if there is a second mode in which only charging is performed. A dedicated contactless charger can be provided for this purpose.

FIG. 5 shows a sectional representation through a near-field communication ring 100 and through a charging bowl 501, wherein the near-field communication ring 100 is shown floating above the charging bowl 501. When the ring is placed in the charging bowl 501, a charging process can start. The charging bowl 501 contains a charging socket 502, a voltage transformer 503 and a charging coil 140.

At the near-field communication ring 100, the first antenna 120 and the second antenna 130 can be seen, wherein the first antenna 120 is attached close to the inner circumference 300, while the second antenna 130 is attached to the outer circumference 301 of the near-field communication ring 100. The second antenna 120 is protected by a protective layer 160 from external influences such as dust or moisture. The second antenna 130 is only visible on one side, because it does not run all over in the near-field communication ring 100, but at most around 20% of the inner circumference 300. In contrast, the first antenna 120 runs around at least 90% of the inner circumference 300. The fact that the first antenna runs around the inner circumference does not mean that it has to be close in the inner circumference 300. In the design presented, it is rather accommodated on the outer circumference. It is also conceivable that the second antenna 130 is provided on the outer circumference 301 in other aspects.

The central axis is labeled with 600 in the figure. The distance of the central axis 600 from the inner circumference 300 is the inner radius rᵢ and the distance from the outer circumference 301 is the outer radius rₐ.

When the near-field communication ring 100 is lowered, the first antenna 120 is located close to the charging coil 140. A plug can be inserted into the charging socket 502, via which electrical energy is supplied. With the aid of the voltage transformer 503, an AC voltage is generated, which excites the charging coil 140, which thus transmits energy to the nearby first antenna 120. The energy is then converted such that the energy storage device 150, as shown in FIG. 3, is charged further.

Using the presented near-field communication ring 100, good transmission properties can be achieved both during charging and during communication.

1. A near-field communication ring designed to be worn by a user, wherein the near-field communication ring comprises:
at least one energy storage device;
a chip;
a first antenna, at least one winding of which runs around at least 90% of an inner circumference of the near-field communication ring; and
a second antenna, at least one winding of which runs around no more than 20% of the inner circumference of the near-field communication ring,
wherein the chip is designed to provide a near-field data exchange with an external device using the first antenna and to charge the energy storage device with aid of the second antenna.

2. The near-field communication ring as claimed in claim 1, wherein the first antenna of which has no more than one winding.

3. The near-field communication ring as claimed in claim 1, wherein the first antenna is formed directly from a metallic carrier material of the near-field communication ring.

4. The near-field communication ring as claimed in claim 1, wherein the second antenna of which contains no more than 5 coils.

5. The near-field communication ring as claimed in claim 1, wherein the first antenna runs on an outside of the near-field communication ring.

6. The near-field communication ring as claimed in claim 1, wherein the first antenna and the second antenna are connected in series and, at least in a first mode, two ends of the series connection are connected to a communication device to communicate with an external device.

7. The near-field communication ring as claimed in claim 6, wherein, at least in a second mode, an end and a connecting node of the series are connected to a charge device to charge a charge storage device.

8. The near-field communication ring as claimed in claim 6, wherein the communication device and/or the charge device are capacitively coupled with the first and second antennas.
